(19) United States
(12) Patent Application Publication
(10) Pub. No.: US 2019/0011005 A1
(43) Pub. Date: Jan. 10, 2019

(54) Type Of Motor Vehicle And Its Automatic Compensation Brake Device

(71) Applicant: Zhejiang CFMOTO Power Co., Ltd., Hangzhou (CN)

(72) Inventors: Xiaolei Zhang, Hangzhou (CN); Haifeng Liang, Hangzhou (CN); Yongjun Liu, Hangzhou (CN)

(21) Appl. No.: 16/029,051

(22) Filed: Jul. 6, 2018

(30) Foreign Application Priority Data
Jul. 6, 2017 (CN) 201710546719.9

(51) Int. Cl. F16D 65/56; F16D 65/18

(52) U.S. Cl. CPC F16D 65/567; F16D 2125/40; F16D 65/18

(57) ABSTRACT

A type of automatic compensation brake device includes the caliper body and the push device. wherein, the push device is used for pushing the brake pad to brake the vehicle, including the push rod, the thread sleeve, and the piston; the piston is arranged on the caliper body by the elastic fixing part and it can be extended and retracted; the piston and the caliper body form the drive chamber which is used for holding the push rod and the thread sleeve; the push rod is arranged inside the drive chamber in a sliding manner; the thread sleeve is rotated freely and connected to the push rod through the thread; the pre-tightening mechanism is arranged between the thread sleeve and the piston; the pre-tightening mechanism is used for pushing the thread sleeve to be rotated and moved along the push rod's axis to be always kept in contact with the piston.

### CROSS-REFERENCE TO RELATED U.S. APPLICATION(S)

None.

### FIELD OF THE INVENTION

The invention relates to the technical field of motor vehicle, particularly to a type of motor vehicle and its automatic compensation brake device.

### BACKGROUND OF THE INVENTION

The disc brake has been widely used in various types of vehicles, because it has high sensitivity and strength, and heat fade does not easily occurs on the disc brake, etc.

The present disc brake device generally includes the brake disc which is arranged on the same axis as the wheel's and the brake pad that can be extended under the pushing of the push device; after the brake pad is extended, it is made contact with the brake disc to brake the vehicle by utilizing friction. However, after the above brake device is used for a period of time, the braking interstice increases and the braking sensitivity decreases due to wear. At this time, it is often necessary to manually adjust the braking interstice, such as adding pads on the brake disc or adjusting the position of the brake pad; the above methods have two disadvantages, one is that time and labour are wasted, the other is that brake interstice can not be adjusted at any time with wear of the brake pad and the brake disc, so the brake interstice is not ensured.

Therefore, how to provide a type of brake device that the brake interstice can be adjusted at any time with wear of the brake pad and the brake disc, the adjustment difficulty can be reduced, and the time can be saved, are technical defects which are urgently need to be solved for those skilled in the art.

### BRIEF SUMMARY OF THE INVENTION

In view of this, the invention provides a type of motor vehicle and its automatic compensation brake device to achieve the purpose that the brake interstice can be adjust at any time with wear of the brake pad and the brake disc, the adjustment difficulty can be reduced, and the time can be saved.

In order to achieve the above objects, this invention provides the following technical scheme:

A type of automatic compensation brake device includes:

Caliper body;

A push device used for pushing the brake pad to brake the vehicle comprises the push rod, the thread sleeve and the piston; the said piston is arranged on the caliper body by an elastic fixing part and it can be extended and retracted; the said piston and the said caliper body form the drive chamber which is used for holding the said push rod and the said thread sleeve; the said push rod is arranged inside the said drive chamber in a sliding manner; the said thread sleeve is rotated freely and connected to the said push rod through the thread; the pre-tightening mechanism is arranged between the said thread sleeve and the said piston; the said pre-tightening mechanism is used for pushing the said thread sleeve to be rotated and moved along the push rod's axis to be always kept in contact with the said piston.

Preferably, the first opening chamber is arranged on the said caliper body; the said piston is arranged inside the said first opening chamber and it can be extended and retracted; the second opening chamber is arranged on the said piston; the said first opening chamber is connected to the said second opening chamber to form the drive chamber.

Preferably, the first end of the push rod is arranged inside the first opening chamber in a sliding manner, the second end of the push rod is connected to the said thread sleeve by the thread and extended into the second opening chamber; the first annular step surface facing towards the bottom of the said second opening chamber is arranged at the opening of the said second opening chamber on the said piston; the second annular step surface facing towards the bottom of the said first opening chamber is arranged on the thread sleeve; the said pre-tightening mechanism is arranged between the said first annular step surface and the said second annular step surface.

Preferably, the said pre-tightening mechanism comprises the compression spring, the gasket plate and the surface bearing; one end of the said compression spring is made contact with the said first annular step surface, the said surface bearing is pressed tightly on the said second annular step surface through the gasket plate on the other end of the said compression spring.

Preferably, the said first opening chamber is provided with the fixed base; the said push rod is provided with the fixed plate; the elastic reset part used for resetting the push rod is arranged between the said fixed base and the said fixed plate.

Preferably, the contact surfaces between the said thread sleeve and the said piston are conical ones.

Preferably, the elastic fixing part is the rectangular ring arranged between the said caliper body and the said piston.

Preferably, the annular groove is arranged on one of the side walls where the said caliper body and the said piston are made contact with each other; the said rectangular ring is arranged in the said annular groove; the avoidance slope is arranged on the side wall where the said annular groove is made contact with the protruding deformation side of the said rectangular ring.

Preferably, the sealing rings are arranged both between the said push rod and the said caliper body and between the said thread sleeve and the said piston.

A type of motor vehicle, including the brake disc which is arranged on the same axis as the wheel's and the brake device utilizing brake pad clamping the said brake disc to brake the vehicle; the said brake device is the said automatic compensation brake device as described in any of the claims above.

From the above technical scheme, it can be known that the automatic compensation brake device provided by the invention comprises the caliper body and the push device; the caliper body is used for fixing the brake pad, and providing installation position and protection for the push device; the push device is used for pushing the brake pad to brake the vehicle, including the push rod, the thread sleeve and the piston; the piston is arranged on the caliper body by an elastic fixing part and it can be extended and retracted; the said piston and the said caliper body form the drive chamber which is used for holding the said push rod and the said thread sleeve; the said push rod is arranged inside the said drive chamber in a sliding manner; the said thread sleeve is rotated freely and connected to the said push rod through the thread; the pre-tightening mechanism is arranged between the said thread sleeve and the said piston; the said pre-tightening mechanism is used for pushing the said thread sleeve to be rotated and moved along the push rod's axis to be always kept in contact with the said piston; In the early stage of use, the push rod drives the thread sleeve to be extended under pushing of the drive structure, and the thread sleeve is pushed-out; here because no wear occurs on the brake pad and the brake disc, the amount of extension of the piston will not exceed the amount of deformation of the elastic fixing part, so no relative sliding occurs between the piston and the elastic fixing part; after the push rod is released, the piston can return to its original position under the action of the elastic fixing part; then there will not exist the interstice between the piston and the thread sleeve; the amount of deformation of the elastic fixing part is basically equal to the brake interstice. In the later stages of use, the brake pad and the brake disc are worn; the push rod and the thread sleeve need to push-out the piston more extension to achieve braking; When the amount of front movement of the piston exceeds the amount of deformation of the elastic fixing part, the relative sliding will occur between the piston and the elastic fixing part; When the push rod is released, the piston can also be retracted under the action of the elastic fixing part, and the amount of retraction at this time is the same as that at the time of early use; however, due to the relative sliding between the elastic fixing part and the piston, the piston is impossible to return to the original position; there will exist the interstice between the piston and the thread sleeve, the pre-tightening mechanism is also compressed; in this case, because the thread sleeve can be rotated freely and connected to the push rod through the thread, the thread sleeve will be rotated and moved along the push rod's axis to be kept in contact with the piston under the push force of the pre-tightening mechanism, then the piston can be extended bit by bit with wear of the brake disc and the brake pad, the brake interstice can be automatically compensated and adjusted, no manual operation is required, the time is saved, the adjustment difficulty is reduced, and the brake interstice can always be guaranteed within the preset range, the braking sensitivity is ensured.

### BRIEF DESCRIPTION OF THE DRAWINGS

In order to describe the technical scheme more clearly in the existing technology or the embodiment of the present invention, the drawings required for the implementation of the existing technology or the embodiment of the present invention are briefly introduced in the following, obviously, the drawings below are some embodiments of the present invention, for the ordinary technical personnel in the art, you can also get other drawings according to these drawings at the premise of without giving creative labor.

FIG. 1 is the schematic view showing the internal structure of the automatic compensation brake device provided by the embodiment of the present invention:

FIG. 2 is the rear view of the automatic compensation brake device provided by the embodiment of the present invention.

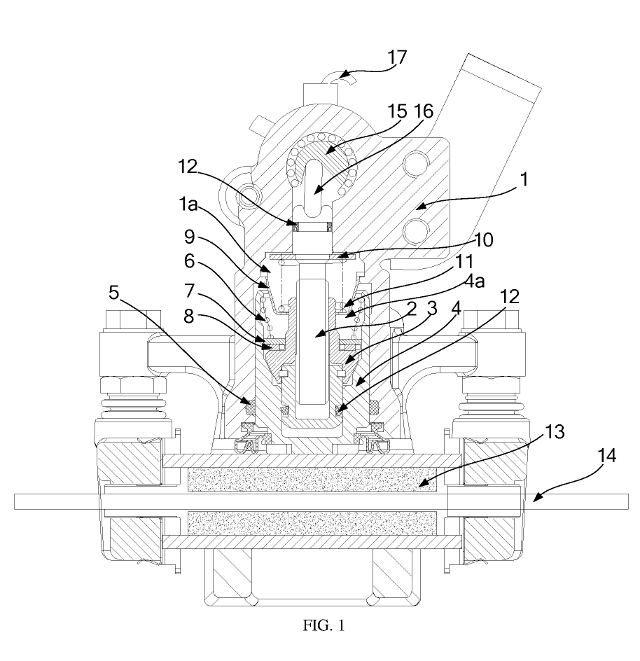

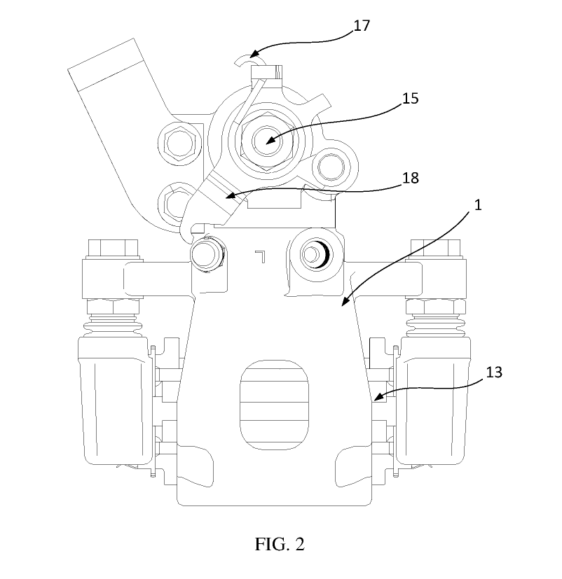

FIG. 1-FIG. 2, the caliper body 1, the push rod 2, the thread sleeve 3, the piston 4, the elastic fixing part 5, the compression spring 6, the gasket plate 7, the surface bearing 8, the fixed base 9, the fixed plate 10, the elastic reset part 11, the sealing ring 12, the brake pad 13, the brake disc 14, the drive shaft 15, the connecting rod 16, the spring lamination 17, the rotating arm 18, the first opening chamber 1a, the second opening chamber 4a.

### DETAILED DESCRIPTION OF THE PREFERRED EMBODIMENTS

The invention provides a type of motor vehicle and its automatic compensation brake device to achieve the purpose that the brake interstice can be adjust at any time with wear of the brake pad and the brake disc, the adjustment difficulty can be reduced, and the time can be saved.

Technical scheme of the embodiment of the present invention is clearly and completely described in the following combined with the accompanying drawings of the embodiment of the present invention; obviously, the embodiment of the present invention is a part of the embodiments, not all of the embodiments of the present invention. Based on the embodiment of the present invention, all other embodiments which the ordinary technical personnel in the art obtain at the premise of without giving creative labor are also deemed to fall into the protection scope of the present invention.

Referring to FIG. 1, it shows the schematic view showing the internal structure of the automatic compensation brake device provided by the embodiment of the invention.

The invention provides a type of automatic compensation brake device, including the caliper body 1 and the push device.

Wherein, the caliper body 1 is used for fixing the brake pad 13, and providing installation position and protection for the push device; the push device is used for pushing the brake pad 13 to brake the vehicle, including the push rod 2, the thread sleeve 3 and the piston 4; the piston 4 is arranged on the caliper body 1 by an elastic fixing part 5 and it can be extended and retracted; the said piston 4 and the said caliper body 1 form the drive chamber which is used for holding the said push rod 2 and the said thread sleeve 3; the said push rod 2 is arranged inside the said drive chamber in a sliding manner; the said thread sleeve 3 is rotated freely and connected to the said push rod 2 through the thread; the pre-tightening mechanism is arranged between the said thread sleeve 3 and the said piston 4; the said pre-tightening mechanism is used for pushing the said thread sleeve 3 to be rotated and moved along the push rod's 2 axis to be always kept in contact with the said piston 4.

Compared with the prior art, the automatic compensation brake device provided by the invention has the technical feature that, in the early stage of use, the push rod 2 drives the thread sleeve 3 to be extended under pushing of the drive structure, and the thread sleeve 3 is pushed-out; here, because no wear occurs on the brake pad 13 and the brake disc 14, the amount of extension of the piston 4 will not exceed the amount of deformation of the elastic fixing part 5, so no relative sliding occurs between the piston 4 and the elastic fixing part 5; after the push rod 2 is released, the piston 4 can return to its original position under the action of the elastic fixing part 5; then there will not exist the interstice between the piston 4 and the thread sleeve 3; the amount of deformation of the elastic fixing part 5 is basically equal to the brake interstice. In the later stages of use, the brake pad 13 and the brake disc 14 are worn; the push rod 2 and the thread sleeve 3 need to push-out the piston 4 more extension to achieve braking; When the amount of front movement of the piston 4 exceeds the amount of deformation of the elastic fixing part 5, the relative sliding will occur between the piston 4 and the elastic fixing part 5; When the push rod 2 is released, the piston 4 can also be retracted under the action of the elastic fixing part 5, and the amount of retraction at this time is the same as that at the time of early use; however, due to the relative sliding between the elastic fixing part 5 and the piston 4, the piston is impossible to return to the original position; there will exist the interstice between the piston 4 and the thread sleeve 3, the pre-tightening mechanism is also compressed; in this case, because the thread sleeve 3 can be rotated freely and connected to the push rod 2 through the thread, the thread sleeve 3 will be rotated and moved along the axis of the push rod 2 to be kept in contact with the piston 4 under the push force of the pre-tightening mechanism; then the piston 4 can be extended bit by bit with wear of the brake disc 14 and the brake pad 13, the brake interstice can be automatically compensated and adjusted, no manual operation is required, the time is saved, the adjustment difficulty is reduced, and the brake interstice can always be guaranteed within the preset range, the braking sensitivity is ensured.

The above push rod 2 is driven by the drive structure; the drive structure can be the hydraulic cylinder, the parking lock, or the combination of the above structure and the transmission mechanism, etc; referring to FIGS. 1 and 2. FIG. 2 shows the rear view of the automatic compensation braking device provided by the embodiment of the present invention; in the embodiment of the invention, the cam connecting rod mechanism 16 is used as the transmission mechanism; the cam connecting rod mechanism 16 comprises the rotating arm 18, the drive shaft 15 and the connecting rod 16; the drive shaft 15 is arranged on the caliper body 1 and can be rotated; the rotating arm 18 is connected to one end of the drive shaft 15; one end of the connecting rod 16 is articulated eccentrically to the drive shaft 15, and the other end is made contact with the push rod 2 in a common manner or articulated to the push rod 2; by the above structure, when the rotating arm 18 is rotated, the drive shaft 15 is also rotated; because the drive shaft 15 is articulated eccentrically to the connecting rod 16, here the drive shaft 15 is acted as a cam, and the connecting rod 16 is pushed, then the push rod 2 is pushed to be moved, so the brake is achieved; further, in order to make the parts to be more conveniently reset, the brake pad 13 is released from the brake disc 14; the spring lamination 17 is arranged between the rotating arm 18 and the caliper body 1; the spring lamination 17 can adopt the separate structure, and it can be also integrated with the rotating arm 18 or the clamp body 1; after the rotating arm 18 is released, the rotating arm 18 will be reset under the action of the spring lamination 17, thus the drive shaft 15 and the connecting rod 16 are driven and reset; if the connecting rod 16 is articulated to the push rod 2, the connecting rod 16 can directly drive the push rod 2 to be reset; if the connecting rod 16 is only made contact with the push rod 2 in a common manner, the reset structure must also be arranged between the push rod 2 and the caliper body 1 to help the push rod 2 to be reset.

From the FIG. 1, it can be known that the structure of the thread sleeve 3 is a split type; adopting split structure has two advantages, on the one hand the thread sleeve 3 is easily manufactured and assembled, on the other hand it can be replaced separately and the cost is reduced; Of course, the thread sleeve 3 can also adopt an integrated structure.

Of course, the above driving structure is only the preferable implementation scheme provided by the embodiment of the present invention; It is actually not limited to this, the requirements will be met as long as the push rod 2 can be extended and retracted, and here it is not limited.

Further optimization of the above technical scheme, a variety of assembling structures can be used between the caliper body 1 and the piston 4. As shown in FIG. 1, the first opening chamber 1a is arranged on the caliper body 1; the piston 4 is arranged inside the first opening chamber 1a and it can be extended and retracted; the second opening chamber 4a is arranged on the piston 4; the first opening chamber 1a is connected to the second opening chamber 4a to form the drive chamber. By the second opening chamber 4a being arranged on the piston 4, the thread sleeve 3 is more easily assembled with the piston 4, but it is not necessary to arrange the second opening chamber 4a.

As shown in FIG. 1, the first end of the push rod 2 is arranged inside the first opening chamber 1a in a sliding manner, the second end of the push rod 2 is connected to the thread sleeve 3 by the thread and extended into the second opening chamber 4a: the first annular step surface facing towards the bottom of the said second opening chamber 4a is arranged at the opening of the said second opening chamber 4a on the said piston 4; the second annular step surface facing towards the bottom of the said first opening chamber 1a is arranged on the thread sleeve 3; the said pre-tightening mechanism is arranged between the said first annular step surface and the said second annular step surface. In this way, when the relative sliding occurs between the piston 4 and the elastic fixing part 5, the distance between the first annular step surface and the second annular step surface will also change, thus the pre-tightening mechanism is compressed to put pressure on the thread sleeve 3.

In order to avoid the rotation of the thread sleeve 3 being affected by the friction between the pre-tightening mechanism and the thread sleeve 3, in the embodiment of the present invention, the pre-tightening mechanism comprises the compression spring 6, the gasket plate 7 and the surface bearing 8; one end of the said compression spring 6 is made contact with the said first annular step surface, the said surface bearing 8 is pressed tightly on the said second annular step surface through the gasket plate 7 on the other end of the said compression spring. In this way, the friction between the pre-tightening mechanism and the thread sleeve 3 is reduced through the surface bearing 8, it is ensured that the thread sleeve 3 can be freely rotated.

As described above, in the case that the connecting rod 16 is only made contact with the push rod 2 in a common manner, the reset structure must be arranged between the push rod 2 and the caliper body 1 to help the push rod 2 to be reset. Of course, in the case that connecting rod 16 is articulated to push rod 2, the reset structure can also be arranged to assist the push rod 2 in being reset. As shown in FIG. 1, in the embodiment of the invention, the fixed base 9 is arranged inside the said first opening chamber 1a; the said push rod 2 is provided with the fixed plate 10; the elastic reset part 11 used for resetting the push rod 2 is arranged between the said fixed base 9 and the said fixed plate 10. When the vehicle is braked, the fixed plate 10 is moved with the top rod 2, but the fixed base 9 is not moved, then the elastic reset part 11 is compressed by the fixed plate 10, the brake pad 13 is extended for braking under the action of the push device; when the push rod 2 is released, the compressed elastic reset part 11 will bounce to push back the push device to the original position.

In order to make the thread sleeve 3 and the piston 4 to be assembled more closely with each other and reduce the friction during the assembly, in the embodiment of the present invention, the contact surfaces between the thread sleeve 3 and the piston 4 are conical ones.

Further optimization of the above technical scheme, in the embodiment of the present invention, the elastic fixing part 5 is the rectangular ring arranged between the caliper body 1 and the piston 4; when wear does not occur on the brake pad 13 and the brake disc 4, the piston 4 is extended and retracted relative to the caliper body 1, as no relative sliding occurs between the piston 4 and the rectangle ring, the amount of movement of the piston 4 is equal to the amount of deformation of the rectangle ring; When the brake disc 14 and the brake pad 13 are worn, the amount of front movement of the piston 4 is greater than the amount of deformation of the rectangle ring, then the piston 4 will slide relative to the rectangle ring, and the amount of retraction of the piston 4 is equal to the amount of deformation of the rectangle ring; That is, the amount of front movement of the piston 4 is greater than the amount of retraction of the piston 4, thus the interstice will occur between the piston 4 and the thread sleeve 3.

Although the thread sleeve 3 can be rotated freely and connected to the push rod 2 through the thread, it must be lubricated enough to be rotated under the pushing of the pre-tightening mechanism; therefore, it is necessary to fill the drive chamber with lubricating oil to achieve the above purpose; in the embodiment of the invention, it is also necessary to isolate the drive chamber from the outside world, so the above rectangular ring not only can play the role of fixing the piston 4 and making it to be reset, but also achieve the purpose of the seal between the piston 4 and the caliper body 1, at the same time, the seal rings 12 are arranged both between the push rod 2 and the caliper body 1 and between the thread sleeve 3 and the piston 4.

In the embodiment of the present invention, the annular groove is arranged on one of the side walls where the caliper body 1 and the piston 4 are made contact with each other, and the rectangular ring is arranged in the annular groove. It should be noted that the rectangular ring will be deformed when the vehicle is braked, the amount of deformation will directly affect the amount of extension and retraction of the piston 4. Therefore, in order to make the annular groove play a good role of fixing the rectangle ring, avoid the annular groove interfering with the rectangle ring during the deformation of the rectangle ring and affecting the deformation of the rectangular ring, the avoidance slope should also be arranged on the side wall that the annular groove is made contact with the protruding deformation side of the rectangular ring.

Specifically, if the annular groove is arranged on the caliper body 1, the rectangular ring in the annular groove will be protruded and deformed towards the direction of the brake pad 13 with the movement of the piston 4; in this case, the avoidance slope should be arranged on the side wall where the annular groove is close to the brake pad 13. If the annular groove is arranged on the piston 4, the rectangular ring will be protruded and deformed towards the direction far away from the brake pad 13 with the movement of the piston 4; in this case, the avoidance slope should be arranged on the side wall where the annular groove keeps far away from the brake pad 13. Of course, in order to ensure that the rectangle ring is fixed, the avoidance slope should be only part of the side wall, not all of it.

The embodiment of the invention also provides a type of motor vehicle, including the brake disc 14 which is arranged on the same axis as the wheel's and the brake device utilizing the brake pad 13 clamping the brake disc 14 to brake the vehicle, here the said brake device is the automatic compensation brake device as described in any of the above.

Each embodiment of the present specification is described in a progressive manner, and each embodiment focuses on the differences with other embodiment, the similar parts between the various embodiment can be referred from each other.

The above descriptions of the disclosed embodiment enable professional and technical personnel in the art to achieve or use the present invention. Obviously, the professional and technical personnel in the art will make many modifications to these embodiment, the general principles defined in this article may be achieve in the other embodiment without departing from the spirit or essential attributes of the present invention. Therefore, this invention will not be limited to the embodiment shown in this article, but to conform to the maximum extent of principles and new features that are disclosed in this article.

1. A type of automatic compensation brake device is characterized in that it includes:
Caliper body;
A push device used for pushing the brake pad to brake the vehicle comprises the push rod, the thread sleeve and the piston; the said piston is arranged on the caliper body by an elastic fixing part and it can be extended and retracted; the said piston and the said caliper body form the drive chamber which is used for holding the said push rod and the said thread sleeve; the said push rod is arranged inside the said drive chamber in a sliding manner; the said thread sleeve is rotated freely and connected to the said push rod through the thread; the pre-tightening mechanism is arranged between the said thread sleeve and the said piston; the said pre-tightening mechanism is used for pushing the said thread sleeve to be rotated and moved along the push rod's axis to be always kept in contact with the said piston.

2. According to claim 1, the said automatic compensation brake device is characterized in that the first opening chamber is arranged on the said caliper body; the said piston is arranged inside the said first opening chamber and it can be extended and retracted; the second opening chamber is arranged on the said piston; the said first opening chamber is connected to the said second opening chamber to form the drive chamber.

3. According to claim 2, the said automatic compensation brake device is characterized in that the first end of the push rod is arranged inside the first opening chamber in a sliding manner, the second end of the push rod is connected to the said thread sleeve by the thread and extended into the second opening chamber; the first annular step surface facing towards the bottom of the said second opening chamber is arranged at the opening of the said second opening chamber on the said piston; the second annular step surface facing towards the bottom of the said first opening chamber is arranged on the thread sleeve; the said pre-tightening mechanism is arranged between the said first annular step surface and the said second annular step surface.

4. According to claim 3, the said automatic compensation brake device is characterized in that the said pre-tightening mechanism comprises the compression spring, the gasket plate and the surface bearing; one end of the said compression spring is made contact with the said first annular step surface, the said surface bearing is pressed tightly on the said second annular step surface through the gasket plate on the other end of the said compression spring.

5. According to claim 2, the said automatic compensation brake device is characterized in that the said first opening chamber is provided with the fixed base; the said push rod is provided with the fixed plate; the elastic reset part used for resetting the push rod is arranged between the said fixed base and the said fixed plate.

6. According to claim 1, the said automatic compensation brake device is characterized in that the contact surfaces between the said thread sleeve and the said piston are conical ones.

7. According to claim 1, the said automatic compensation brake device is characterized in that the elastic fixing part is the rectangular ring arranged between the said caliper body and the said piston.

8. According to claim 7, the said automatic compensation brake device is characterized in that the annular groove is arranged on one of the side walls where the said caliper body and the said piston are made contact with each other; the said rectangular ring is arranged in the said annular groove; the avoidance slope is arranged on the side wall where the said annular groove is made contact with the protruding deformation side of the said rectangular ring.

9. According to claim 1, the said automatic compensation brake device is characterized in that the sealing rings are arranged both between the said push rod and the said caliper body and between the said thread sleeve and the said piston.

10. A type of motor vehicle, including the brake disc which is arranged on the same axis as the wheel's and the brake device utilizing brake pad clamping the said brake disc to brake the vehicle, is characterized in that the said brake device is the automatic compensation brake device as described in claim 1.
